(19) United States
(12) Patent Application Publication
(10) Pub. No.: US 2026/0349771 A1
(43) Pub. Date: Nov. 5, 2026

(54) Adaptive Accessibility System for Multimodal Gesture Interaction, UI Personalization, and Real-Time Task Guidance

(71) Applicant: Oladayo Ayokunle Luke, CAMPBELL, CA (US)

(72) Inventor: Oladayo Ayokunle Luke, CAMPBELL, CA (US)

(73) Assignee: Perdurable Group inc., Campbell, CA (US)

(21) Appl. No.: 19/683,727

(22) Filed: May 21, 2026

Related U.S. Application Data
(63) Continuation-in-part of application No. 19/040,873, filed on Jan. 30, 2025.

(51) Int. Cl. G06F 9/451; G06F 3/01; G06F 3/0488; G06V 10/764; G06V 40/20; G09B 21/00

(52) U.S. Cl. CPC G06F 9/453; G06F 3/017; G06F 3/0488; G06V 10/764; G06V 40/28; G09B 21/009

(57) ABSTRACT

An adaptive accessibility system and method are disclosed for enabling touchless, multimodal digital interaction through reactive non-blocking gesture orchestration, AI-assisted accessibility guidance, and personalized interface adaptation. Using standard camera hardware, lightweight machine learning models, immutable frame-scoped telemetry, and browser-native technologies, the system interprets user gestures in real time while dynamically adapting to environmental conditions, user behavior, and interaction context. A role-based interaction engine enables simultaneous pointer interaction, navigation, typing, dwell activation, and command execution through independent reactive interaction streams without centralized gesture arbitration. An AI-driven accessibility coach provides contextual visual, auditory, or multimodal guidance for workflows including login, navigation, communication, and form interaction. The system further supports gesture-to-text, gesture-to-voice, and gesture-to-command translation, shared accessibility profiles, adaptive UI personalization, and cross-platform deployment without requiring proprietary hardware.

### CROSS-REFERENCE TO RELATED APPLICATION

This application is a Continuation-in-Part (CIP) of U.S. Provisional Patent Application No. Ser. No. 19/040,873, filed on Jan. 30, 2025, entitled “Unified System for Gesture Recognition, Text Generation, and Multi-Modal Communication,” which is hereby incorporated by reference in its entirety as if set forth fully herein for all purposes.

The present application expands upon these foundations by introducing a system that provides adaptive gesture-based accessibility, real-time multimodal task guidance, behavioral personalization, environmental adaptation, and UI reconfiguration tailored to users' physical, cognitive, and linguistic needs.

### TECHNICAL FIELD

The present invention relates generally to human-computer interaction and accessibility technologies. More specifically, it pertains to systems and methods for enabling adaptive, touchless, and multimodal user interfaces through gesture recognition, real-time task guidance, and personalized UI configurations, with a focus on improving digital accessibility for users with physical, cognitive, sensory, or linguistic impairments.

The present invention further relates to non-blocking multimodal interaction orchestration systems capable of concurrently processing independent gesture, pointer, navigation, dwell, and accessibility interaction streams in real time using reactive event-based processing architectures.

### BACKGROUND

Many users with physical, cognitive, or sensory impairments face significant barriers when interacting with traditional digital interfaces that rely heavily on manual input methods such as keyboards, mice, or touchscreens. While assistive technologies like screen readers, switch devices, or voice control have improved inclusivity, they often lack adaptability, personalization, or seamless integration across diverse platforms and devices. Furthermore, these systems tend to offer one-size-fits-all functionality, failing to dynamically adjust to the user's environment, skill level, or changing needs.

Conventional accessibility frameworks also fall short in providing real-time guidance during complex tasks such as form filling, navigation, or digital transactions, leading to frustration or abandonment. Users with hearing impairments, motor challenges, or limited digital literacy require a more responsive and context-aware system capable of guiding them through interactions in a modality suited to their capabilities.

Conventional accessibility systems further fail to support concurrent multimodal interaction ownership between independent limbs or gesture sources, thereby limiting usability for users requiring simultaneous spatial interaction and command execution.

Additionally, few existing platforms support gesture-to-text or gesture-to-voice translation for Deaf users or offer gesture-based customization of user interface elements such as size, control layout, or interaction precision. There is a critical need for an adaptive system that can combine multimodal inputs such as gestures, visual cues, and voice prompts with AI-driven learning to tailor digital environments in real time, thereby enhancing usability, autonomy, and inclusion. This invention addresses these challenges with a novel, intelligent accessibility architecture designed to adapt dynamically to user preferences, contexts, and interaction styles.

Existing gesture recognition systems typically employ synchronous gesture arbitration models in which multiple detected gestures are collapsed into a single dominant interaction event per processing frame. Such architectures prevent simultaneous interaction modalities including concurrent pointing, navigation, typing, dwell activation, or accessibility guidance workflows.

### PRIOR ART

Numerous prior systems have explored gesture recognition, multimodal input, and adaptive user interfaces aimed at improving digital accessibility. These include solutions leveraging facial recognition, gesture classification, and UI personalization frameworks. However, most of such inventions remain limited in scope either relying on predefined gesture sets, requiring specialized hardware, or lacking cultural and linguistic adaptability. The following prior art references illustrate existing approaches in the field but fall short of delivering an integrated, AI-driven, and environment-adaptive accessibility system tailored for diverse user capabilities and regional needs.

US 2025/0191405A1—Multi-Modal Articulation System: Existing solutions for gesture-based interaction in software applications often rely on proprietary hardware ecosystems, closed gesture libraries, or platform-specific development kits, limiting interoperability and adoption.

U.S. Pat. No. 7,554,522 B2—Personalization of User Accessibility Options: Describes a system that adjusts UI characteristics based on user preferences to improve accessibility.

US 2010/0281435 A1—Multimodal Interaction System: Details a platform for editing gesture input among multiple input modes.

US 2004/0218451 A1—Accessible User Interface & Navigation System: Outlines an interface tailored to various impairments through template-based features.

While the cited prior art has contributed foundational methods in gesture interpretation and user interface adjustment, none disclose or suggest the combined use of real-time AI-driven task guidance, multilingual gesture translation, personalized gesture biometrics, environment-aware gesture adaptation, or the portability of shared accessibility profiles across platforms. The present invention addresses these limitations by introducing a holistic, modular, and culturally inclusive accessibility architecture designed for practical deployment in standard web and mobile environments.

### Unfulfilled Need

Despite advancements in assistive technologies and gesture-based interfaces, there remains a critical unmet need for an adaptive, culturally inclusive, and real-time accessibility system that can support users through diverse physical, cognitive, and linguistic abilities. Current systems often lack dynamic personalization, rely on fixed gesture vocabularies not reflective of regional sign languages like Yoruba, Igbo, or Hausa, and fail to adjust in real time to environmental factors such as lighting, background, or device limitations.

Furthermore, existing platforms do not offer a task-aware AI coach that can guide users through digital interactions such as form filling, navigation, or secure authentication. There is also no provision for gesture-to-voice or gesture-to-text translation tailored for the Deaf and hard-of-hearing, nor support for shared accessibility profiles that allow users or caregivers to transfer settings across devices.

This unfulfilled gap demands a new system that can combine multimodal gesture input, machine learning-based personalization, environment-sensitive adaptation, and multilingual inclusivity into a seamless accessibility layer for modern digital interfaces.

There remains a need for a reactive interaction architecture capable of independently orchestrating simultaneous gesture-derived interaction streams including pointer interaction, command execution, dwell confirmation, typing, navigation, and accessibility guidance without requiring sequential gesture arbitration or mutual suppression between interaction channels.

### Failures of Others

Existing gesture-based and accessibility systems have consistently fallen short in addressing the multifaceted needs of users with diverse physical, linguistic, and environmental contexts. Many prior inventions require specialized hardware, such as depth cameras or motion sensors, limiting their scalability in low-resource environments.

Other solutions offer static gesture recognition or UI customization but lack real-time guidance, environmental adaptability, or the ability to personalize gesture precision and interaction styles over time. These systems also typically do not support multimodal integration, such as combining gesture input with voice output or real-time gesture-to-text translation.

Additionally, current accessibility platforms do not support shared user profiles that travel across devices or sessions forcing users to reconfigure preferences repeatedly. The lack of behavioral learning, privacy-conscious gesture biometrics, and dynamic task assistance underscores a systemic failure in delivering inclusive, adaptable, and scalable accessibility technologies. The present invention directly addresses these shortcomings.

Prior systems commonly process gesture recognition through centralized winner-selection pipelines that select a single “best gesture” from multiple detected gestures per frame. Such approaches prevent parallel interaction execution, produce unstable accessibility behavior, and interrupt continuous workflows such as dwell selection during simultaneous navigation or command issuance.

### Problems With Prior Art

Existing gesture-based accessibility systems suffer from several key limitations that restrict their effectiveness across diverse user populations and contexts. Most systems rely on static gesture libraries, often tailored to Western sign languages or fixed control schemes, with little or no support for personalized gesture signatures that adapt to individual behavior. They also lack adaptive UI reconfiguration, making them unsuitable for users with varying motor skills, visual requirements, or device types.

Prior solutions do not provide real-time, context-aware guidance such as an AI-driven accessibility coach to help users complete tasks like form filling, authentication, or navigation. Furthermore, traditional platforms fail to dynamically adjust gesture sensitivity, input thresholds, or interface complexity based on environmental variables like lighting, background noise, or camera quality.

Another common shortfall is the absence of shared accessibility profiles, which would allow users or caregivers to transfer preferences across sessions and devices for consistency and convenience. Finally, current systems do not support gesture-to-text or gesture-to-voice translation, excluding users who rely on non-verbal communication. The present invention addresses all these gaps by combining adaptive gesture control, multimodal translation, task-specific guidance, and real-time personalization into a single, scalable accessibility architecture.

Traditional gesture systems also lack role-based interaction ownership mechanisms capable of assigning independent interaction responsibilities to separate hands or limbs. Existing systems therefore cannot reliably support concurrent pointer interaction, command execution, and multimodal accessibility assistance in real time.

Traditional gesture systems also lack role-based interaction ownership mechanisms capable of assigning independent interaction responsibilities to separate hands or limbs. Existing systems therefore cannot reliably support concurrent pointer interaction, command execution, and multimodal accessibility assistance in real time.

### Serious Nature of the Problem

The inability of digital systems to accommodate diverse user abilities and preferences represents a fundamental barrier to equitable technological access. Individuals with physical, cognitive, or sensory impairments often encounter digital interfaces that are rigid, visually complex, or reliant on input modalities they cannot use such as keyboards, touchscreens, or voice commands. This exclusion not only impedes their ability to navigate essential online services, including healthcare, education, and banking, but also perpetuates systemic digital inequity.

Moreover, the lack of adaptive systems that can personalize interaction based on real-time user context or environmental conditions (e.g., lighting, noise, device quality) results in high error rates, abandonment of tasks, and loss of independence for users who need consistent accessibility support. Without tools to adjust gesture precision, reconfigure UI complexity, or offer real-time guidance, many users are effectively locked out of critical digital workflows. The problem is not simply inconvenience, it is a serious impediment to autonomy, inclusion, and the digital rights of people with disabilities.

### SUMMARY OF THE INVENTION

The present invention discloses a system and method for enabling touchless, gesture-enhanced user interactions through modular integration plugins and APIs. Designed for cross-platform compatibility and client-side execution, the invention allows developers to seamlessly bind gesture recognition capabilities to existing digital interfaces particularly form fields, interactive UI elements, and DOM-controlled workflows without requiring extensive codebase alterations or specialized hardware.

At its core, the system comprises a gesture processing engine that uses a vision-based input module (e.g., webcam) to capture hand movements, a lightweight machine learning model for gesture classification, and a command dispatcher that translates recognized gestures into UI-level actions. These actions may include pointer simulation (click, drag, hover), form element interaction (field focus, checkbox toggle, drag-to-position), or navigation controls.

To enable widespread usability, the system exposes its functionality via configurable browser plugins, SDKs, and middleware packages. These tools support declarative DOM gesture binding, dynamic gesture-mode switching, secure input validation, and developer-defined gesture-action mapping.

Unlike existing systems that require embedded platforms or custom hardware environments, the invention operates entirely within browser contexts, mobile WebView, or platform-native UIs using browser-compatible standards such as WebAssembly and TensorFlow.js. It is optimized for accessibility use cases, secure digital forms, and gesture-conditioned authentication workflows.

In one embodiment, the invention introduces a non-blocking reactive interaction orchestration architecture in which immutable frame-scoped gesture telemetry is distributed through independent interaction streams corresponding to pointer interaction, command interaction, dwell activation, navigation, accessibility guidance, typing, and multimodal feedback systems.

The system further includes a role assignment engine configured to dynamically assign interaction ownership roles including pointer, commander, or idle states to detected hands or gesture sources, thereby enabling concurrent multimodal interaction without gesture arbitration conflicts.

Independent interaction consumers may subscribe to role-scoped interaction streams without blocking sibling interaction pipelines, thereby enabling simultaneous accessibility workflows including pointer movement during command execution or dwell confirmation during navigation.

The invention supports adaptive gesture behavior based on contextual cues and integrates feedback systems to guide the user visually or aurally through successful gesture completion. Its modularity and extensibility allow its deployment in standalone applications or as an embeddable layer across third-party services, establishing a scalable foundation for touchless, secure, and intelligent human-computer interaction.

### Functional Benefits

The invention introduces a comprehensive, adaptive accessibility system that enhances multimodal human-computer interaction through the following core capabilities:

Personalized Gesture Signatures: Enables secure identity verification via user-specific gesture patterns, particularly valuable for individuals who cannot utilize fingerprint or facial biometrics.

Shared Accessibility Profiles: Allows users or caregivers to import/export accessibility settings across devices, sessions, and platforms, ensuring consistent experiences.

Task-Specific Accessibility Modes: Dynamically adjusts gesture sets and UI behavior depending on the task, simplified input during login, detailed navigation for browsing, or precise control for editing.

Environment-Aware Input Adjustment: Automatically calibrates gesture sensitivity based on ambient lighting, camera specifications, and environmental noise to maintain recognition accuracy.

Behavioral Adaptation via ML: Learns user habits over time to adjust gesture thresholds, timing, and interaction preferences, improving personalization and reducing errors.

Dynamic UI Element Labeling: Enables gestures to trigger auditory or text-based descriptions of interface components, improving screen-reader-like accessibility through visual interaction.

AI-Driven Accessibility Coach: Offers real-time, gesture-guided assistance for completing digital forms, authentication flows, and general UI navigation.

Configurable UI Reconfiguration: Supports user-defined adjustments to interface size, gesture precision, control layout, and platform interaction models via preference or subscription settings.

Multimodal Gesture Translation: Provides real-time conversion of gestures to text, voice, or commands, supporting Deaf or hard-of-hearing users and drawing on capabilities referenced in U.S. patent application Ser. No. 19/040,87.

Non-Blocking Interaction Orchestration: Enables simultaneous processing of pointer interaction, command execution, dwell activation, typing, navigation, and accessibility assistance without requiring sequential gesture arbitration.

Role-Based Interaction Ownership: Dynamically assigns gesture ownership roles to separate hands or gesture sources to support stable multimodal accessibility workflows and concurrent interaction execution.

Reactive Accessibility Streams: Allows accessibility modules to independently consume gesture telemetry through reactive event streams, improving responsiveness, modularity, and extensibility.

### Key Innovative Aspects

The disclosed invention introduces several novel features that distinguish it from existing accessibility and gesture-based interaction systems:

Real-Time Adaptive Gesture Recognition: Unlike fixed gesture libraries, this system dynamically adjusts recognition sensitivity and timing based on user behavior and environmental conditions, using machine learning to refine gesture profiles over time.

AI-Driven Accessibility Coach: A unique module that provides real-time, context-aware task guidance helping users navigate complex digital tasks such as form filling or authentication through visual prompts or gesture cues.

Multimodal Gesture Translation: Integrates gesture-to-text, gesture-to-voice, and gesture-to-command conversion for users with hearing impairments or speech limitations bridging communication gaps in a seamless, browser-native experience.

Shared and Portable Accessibility Profiles: Enables the export and import of personalized accessibility settings across devices, platforms, or caregivers, ensuring consistent and inclusive user experiences.

Task-Specific Interaction Modes: Supports different UI behavior and gesture configurations depending on the task e.g., simplified gestures during login, precision gestures during document editing, or guided steps during navigation.

UI Reconfiguration via Subscription or Preference: Offers flexible interface customization including control layout, gesture precision, interface size, and camera detection model based on user preferences or subscription tiers.

Personalized Gesture Biometrics: Employs user-specific gesture signatures for secure identity verification, providing a viable alternative to traditional biometrics like fingerprint or face recognition.

Dynamic Element Labeling Through Gesture: Combines gestures with screen-reader functionality to label or describe nearby UI components using auditory or textual feedback, improving accessibility for visually impaired users.

Environment-Aware Interaction Calibration: Continuously monitors ambient conditions such as lighting, camera angle, and noise to optimize gesture detection accuracy without requiring user intervention.

Reactive Frame-Centric Interaction Architecture: Unlike systems that collapse multiple gestures into a single dominant interaction, the disclosed invention distributes immutable frame-scoped telemetry through independent reactive interaction streams capable of concurrently supporting pointer interaction, command execution, dwell activation, navigation, and accessibility workflows.

Dynamic Interaction Role Assignment: The invention introduces a role assignment engine that assigns interaction ownership roles such as pointer, commander, or idle to independent gesture sources, thereby enabling stable concurrent multimodal interaction.

Independent Interaction Consumers: Accessibility subsystems independently subscribe to interaction streams without centralized arbitration, thereby reducing interaction suppression and improving responsiveness in concurrent workflows.

These innovations form a robust, modular, and user-centric system designed to deliver inclusive, adaptive, and secure digital interactions across a wide range of devices and user abilities.

### BRIEF DESCRIPTION OF THE FIGURES

FIG. 1 illustrates the system architecture (100) of the Adaptive Accessibility System. It includes seven functional groups: (101) Input & Sensing Layer with Camera Input Module (102) and Environmental Sensor Interface (104); (103) Gesture Processing Core with Gesture Recognition Engine (106) and Biometrics Validator (108); (105) Adaptive Interaction Manager with Adaptation Manager (110), Task Mode Selector (112), and UI Context Monitor (114); (107) Accessibility Personalization Layer with Profile Manager (116) and UI Adapter (118); (109) Interaction Layer with Interaction Mapper (120) and Command Dispatcher (122); (111) Assistive Feedback & Guidance with Accessibility Coach (124) and Feedback Renderer (126); and (113) Multimodal Output Translator with Gesture-to-Text Converter (128) and Gesture-to-Voice Converter (130). Each component communicates to enable real-time gesture-based interaction and accessibility personalization.

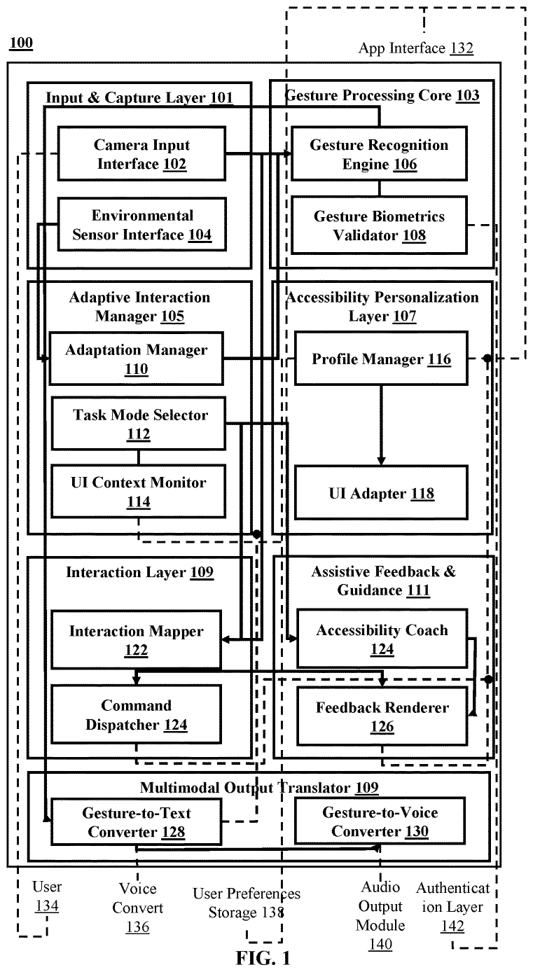

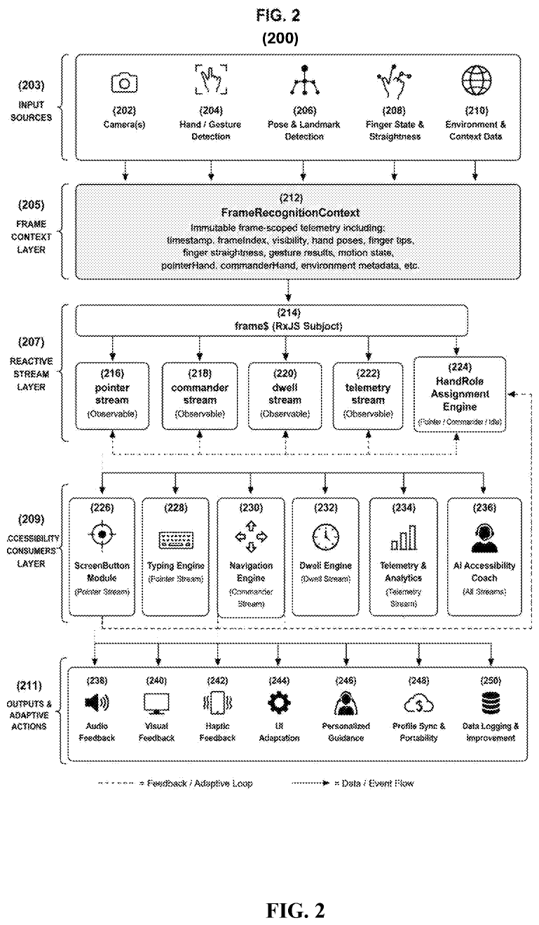

In the system architecture illustrated in FIG. 1, several external components identified by dashed-line connections interact with internal system modules while residing outside the core processing pipeline. These include the User (134), who initiates gesture interactions via the Camera Input Module (102) and receives responsive feedback through the User Interface, which is functionally equivalent to the App Interface (132). The App Interface (132) represents the host environment that receives DOM-level events, gesture-generated input, and adaptive UI adjustments from components such as the Command Dispatcher (122), UI Adapter (118), and Gesture-to-Text Converter (128).

FIG. 2 illustrates an example reactive multimodal interaction orchestration architecture (200) including a FrameRecognitionContext layer (205), a reactive stream layer (207), a HandRoleAssignmentEngine (224), independent accessibility consumers (209), and adaptive output systems (211). In certain embodiments, immutable frame-scoped telemetry is distributed through independent interaction streams including a pointer stream (216), commander stream (218), dwell stream (220), and telemetry stream (222) to enable non-blocking concurrent accessibility interaction, multimodal gesture processing, adaptive UI interaction, and accessibility guidance workflows.

### DETAILED DESCRIPTION OF FIGURES

FIG. 1 illustrates the system architecture (100) for the Adaptive Accessibility System for Multimodal Gesture Interaction, UI Personalization, and Real-Time Task Guidance. This architecture comprises seven logical groups, each containing specialized components designed to process gesture input, adapt user interfaces, and facilitate inclusive interaction across web and mobile platforms.

The Input & Sensing Layer (101) initiates the data pipeline. The Camera Input Module (102) captures live video streams of the user's hand or face gestures using standard device cameras. Simultaneously, the Environmental Sensor Interface (104) collects contextual data such as ambient light, background contrast, or noise levels, which informs downstream adaptation logic.

The Gesture Processing Core (103) includes the Gesture Recognition Engine (106), which applies AI/ML models to classify gestures (e.g., swipe, hold, sign). The Gesture Biometrics Validator (108) uses trained models to verify user identity through unique gesture signatures, serving as a touchless biometric authentication alternative.

In the Accessibility Personalization Layer (107), the Profile Manager (116) manages portable accessibility settings, enabling users or caregivers to export/import preferences across devices or applications. The UI Adapter (118) reconfigures layout elements such as gesture targets, control size, or interaction models based on these profiles.

The Multimodal Output Translator (113) bridges communication for users with speech impairments. The Gesture-to-Text Converter (128) translates recognized gestures into text for input fields or messaging. The Gesture-to-Voice Converter (130) then vocalizes those inputs for environments requiring auditory output or interaction with voice-driven systems.

The Voice Converter (136) supports speech output workflows by receiving text input from the Gesture-to-Text Converter (128) and forwarding it to the Gesture-to-Voice Converter (130). The resulting synthesized speech is then delivered via the Audio Output Module (140), providing audible assistance to non-verbal users. Meanwhile, the User Preferences Storage (138) serves as a persistent external data source for storing and retrieving accessibility profiles, which are loaded by the Profile Manager (116) for interface adaptation.

Additionally, the authentication layer (142) operates as an external security service, receiving verified identity output from the Gesture Biometrics Validator (108). All these components connected by dashed lines illustrate the system's ability to operate flexibly in conjunction with application-layer services, external storage, voice pipelines, and identity frameworks, while maintaining modular boundaries and supporting real-time gesture-based accessibility and security.

Together, FIG. 1 components enable a modular, privacy-conscious, and culturally adaptable system for enhancing accessibility through intelligent, touchless interaction.

Referring to FIG. 2, an example reactive multimodal interaction orchestration architecture (200) is illustrated. The architecture includes an input source layer (203), a frame context layer (205), a reactive stream layer (207), an accessibility consumer layer (209), and an adaptive output layer (211). In certain embodiments, the architecture enables concurrent non-blocking accessibility interaction through independent reactive processing streams derived from immutable frame-scoped telemetry.

The input source layer (203) may include one or more cameras or imaging devices (202), hand or gesture detection systems (204), pose and landmark detection systems (206), finger-state and finger-straightness detection systems (208), and environment or contextual data sources (210). In certain embodiments, the input sources continuously acquire multimodal interaction telemetry including hand pose information, finger-tip coordinates, motion information, visibility states, environmental metadata, and accessibility interaction context.

In some embodiments, telemetry from the input source layer (203) is normalized into a FrameRecognitionContext object (212) within the frame context layer (205). The FrameRecognitionContext may comprise immutable frame-scoped telemetry including timestamps, frame indexes, visibility scores, hand pose snapshots, finger-tip telemetry, finger-straightness states, gesture recognition outputs, motion state information, environmental metadata, interaction ownership information, and accessibility interaction context. In certain embodiments, the FrameRecognitionContext serves as a canonical interaction payload distributed through reactive interaction streams.

The reactive stream layer (207) may include a frame stream (214), which in certain embodiments is implemented as a reactive event stream or observable sequence configured to distribute immutable frame-scoped telemetry to independent interaction consumers. The frame stream (214) may generate or feed one or more specialized interaction streams including a pointer stream (216), a commander stream (218), a dwell stream (220), and a telemetry stream (222).

In certain embodiments, the pointer stream (216) is configured to process continuous spatial interaction telemetry including cursor movement, hover interaction, dwell interaction, typing interaction, and accessibility targeting. The commander stream (218) may independently process command-oriented interactions including navigation commands, popup interaction, command shortcuts, selection actions, confirmation actions, and accessibility control operations. The dwell stream (220) may process dwell confirmation telemetry including finger-straightness states, dwell timers, hover persistence, and activation confidence metrics. The telemetry stream (222) may process analytics, debugging information, performance telemetry, interaction metrics, accessibility adaptation data, or environmental context data.

In some embodiments, a HandRoleAssignmentEngine (224) dynamically assigns interaction ownership roles to detected hands or gesture sources. Roles may include pointer, commander, or idle states. In certain embodiments, the role assignment engine assigns ownership independently of semantic gesture meaning, thereby allowing downstream systems to independently interpret role-scoped interaction streams. The HandRoleAssignmentEngine may further stabilize ownership assignments through temporal persistence windows, confidence scoring, visibility tracking, or adaptive reassignment rules to prevent rapid interaction flickering or unintended ownership transitions.

In certain embodiments, the accessibility consumer layer (209) includes one or more independent accessibility interaction systems configured to consume reactive interaction streams without centralized gesture arbitration. Such systems may include a ScreenButtonModule (226), a typing engine (228), a navigation engine (230), a dwell engine (232), telemetry and analytics systems (234), and an AI accessibility coach (236).

The ScreenButtonModule (226) may consume the pointer stream (216) to support adaptive button targeting, dwell selection, spatial accessibility interaction, and multi-finger activation workflows. The typing engine (228) may consume pointer-derived telemetry to support adaptive text input, virtual keyboard interaction, gesture-assisted typing, or accessibility-focused text entry systems. The navigation engine (230) may consume the commander stream (218) to process directional navigation, popup interaction, accessibility control commands, or adaptive workflow transitions. The dwell engine (232) may consume the dwell stream (220) to determine dwell confirmation events, adaptive selection thresholds, or accessibility activation confidence levels.

In certain embodiments, telemetry and analytics systems (234) process telemetry streams (222) to generate performance metrics, accessibility analytics, adaptive interaction profiling, environmental adaptation metrics, or predictive accessibility behavior models. The AI accessibility coach (236) may consume one or more reactive streams to generate adaptive guidance, personalized accessibility recommendations, contextual workflow assistance, multimodal interaction suggestions, or task-aware accessibility support.

In some embodiments, the accessibility consumer layer (209) produces adaptive outputs and feedback actions within the output layer (211). Such outputs may include audio feedback systems (238), visual feedback systems (240), haptic feedback systems (242), adaptive user interface systems (244), personalized accessibility guidance systems (246), profile synchronization systems (248), and telemetry logging or improvement systems (250).

In certain embodiments, the architecture enables simultaneous multimodal interaction without requiring centralized winner-selection gesture arbitration. For example, a first hand assigned to a pointer role may continue controlling cursor interaction or dwell targeting while a second hand assigned to a commander role independently performs navigation or command actions. Because interaction streams operate independently, accessibility workflows may continue concurrently without interruption, suppression, or forced serialization between gesture pipelines.

In some embodiments, feedback or adaptive learning loops may be generated between accessibility consumers and upstream reactive interaction streams, thereby allowing adaptive interaction optimization, personalized accessibility adjustment, predictive workflow adaptation, or environment-aware accessibility behavior refinement over time.

Although FIG. 2 illustrates reactive interaction streams and accessibility consumers, other embodiments may include additional interaction streams, multimodal telemetry pipelines, accessibility modules, environmental adaptation systems, AI interaction systems, or gesture-processing architectures without departing from the scope of the present disclosure.

### DETAILED DESCRIPTION OF THE INVENTION

The present invention discloses a modular, adaptive accessibility system that enables inclusive, multimodal digital interaction through gesture-based input, real-time UI personalization, and AI-guided task support. This system is designed to improve accessibility for users with diverse needs by integrating gesture recognition, behavioral learning, and dynamic interface adaptation across web and mobile platforms. As shown in FIG. 1, the architecture (100) consists of multiple functional layers, each supporting one or more of the system's innovative capabilities.

At its core, the Input & Sensing Layer (101) captures user gestures using standard webcams through the Camera Input Module (102), while the Environmental Sensor Interface (104) detects real-time ambient conditions such as lighting, device orientation, or background noise. This information is fed forward to enhance gesture accuracy and system responsiveness.

The Gesture Processing Core (103) is responsible for interpreting the captured gestures. The Gesture Recognition Engine (106) utilizes AI/ML models to classify gesture types ranging from hand movements to facial cues while the Gesture Biometrics Validator (108) enables personalized identity verification based on unique gesture signatures. This supports the innovative aspect of touchless biometric authentication, an alternative to traditional fingerprint or face ID, particularly beneficial for users with mobility or facial uniqueness constraints.

In the Adaptive Interaction Manager (105), the Adaptation Manager (110) adjusts system sensitivity and timing based on environmental data and learned user behavior realizing the innovation of behavioral and environment-aware adaptation. The UI Context Monitor (114) detects current digital tasks and passes control to the Task Mode Selector (112), which activates gesture configurations for login, navigation, or editing modes, addressing task-specific accessibility workflows.

The Accessibility Personalization Layer (107) enables flexible UI reconfiguration and preference portability. The Profile Manager (116) allows users or caregivers to import/export accessibility settings, while the UI Adapter (118) modifies gesture precision, element size, and layout in real time. This layer embodies the innovation of shared accessibility profiles and subscription-based UI customization.

Within the Interaction Layer (109), the Interaction Mapper (120) translates recognized gestures into actionable UI events, which the Command Dispatcher (122) executes via system or DOM-level commands. These components facilitate seamless interaction without physical input devices, supporting gesture-to-command mapping.

The Assistive Feedback & Guidance Layer (111) includes the Accessibility Coach (124), which acts as a real-time task guide by offering gesture prompts or visual aids. Paired with the Feedback Renderer (126), which reflects system state changes visually or audibly, this layer introduces a real-time AI accessibility coach a key differentiator not found in conventional accessibility systems.

Finally, the Multimodal Output Translator (113) bridges communication for non-verbal users. The Gesture-to-Text Converter (128) enables gesture typing, while the Gesture-to-Voice Converter (130) allows for spoken output fulfilling the innovation of gesture-to-text/voice multimodal translation, particularly vital for Deaf or hard-of-hearing individuals.

Host Interaction Layer (209): The Host Interaction Layer facilitates the exchange of data and events between the extension and the web application it interacts with. It includes the App/Host Application (210), which triggers and receives Custom Events; the Permission Layer (212), which enforces domain access and API communication rules; and the Storage Layer (214), responsible for persisting configuration data, encrypted credentials, or session metadata. This layer forms the interface between the extension and its operational environment.

The invention is architected to operate within standard web, mobile, or desktop environments while interfacing seamlessly with external systems critical to accessibility, personalization, and security. As shown in FIG. 1, the system includes dashed-line connections to several external components. The App Interface (132) acts as both the rendering surface and command receiver for UI updates, DOM events, and adaptive layout changes triggered by internal modules such as the Command Dispatcher, UI Adapter, and Gesture-to-Text Converter. The User (134) interacts with the system via gestures and receives feedback through on-screen visuals or synthesized voice. The Voice Converter (136) and Audio Output Module (140) work in conjunctions to support non-verbal users, transforming recognized gesture text into audible speech output. The User Preferences Storage (138) enables accessibility profiles to be retrieved or synced across sessions or devices. Finally, the Authentication Layer (142) functions as a secure endpoint for verifying identity claims produced by the Gesture Biometrics Validator. These external components extend the system's utility beyond standalone execution, allowing real-time integration with personalized services, assistive technologies, and authentication frameworks across diverse environments.

Referring generally to FIG. 2, the present invention provides a reactive multimodal interaction orchestration architecture (200) configured to support concurrent non-blocking accessibility interaction using independent role-scoped interaction streams derived from immutable frame-scoped telemetry. In certain embodiments, the architecture enables simultaneous pointer interaction, command execution, dwell activation, typing, navigation, accessibility guidance, and adaptive interaction workflows without requiring centralized gesture arbitration or single-gesture winner selection.

In some embodiments, one or more input sources within the input source layer (203) continuously capture multimodal interaction telemetry from a user environment. Such input sources may include cameras or imaging devices (202), gesture detection systems (204), pose and landmark detection systems (206), finger-state or finger-straightness detection systems (208), and contextual or environmental data sources (210). The input sources may generate telemetry including hand landmarks, finger-tip positions, pose vectors, visibility states, motion data, dwell indicators, gesture classifications, interaction confidence values, environmental conditions, and accessibility interaction metadata.

In certain embodiments, telemetry acquired from the input source layer (203) is normalized into a FrameRecognitionContext object (212) within the frame context layer (205). The FrameRecognitionContext may comprise immutable frame-scoped interaction telemetry associated with a particular processing frame or temporal interaction interval. In some embodiments, the FrameRecognitionContext includes timestamps, frame indexes, gesture metadata, hand pose snapshots, finger-tip telemetry, finger-straightness states, motion detection data, visibility information, accessibility interaction state, environmental metadata, and role assignment information.

In certain embodiments, immutable frame-scoped telemetry improves interaction consistency and enables downstream interaction consumers to independently process interaction information without mutating upstream recognition state. The use of immutable frame contexts further enables deterministic replay, telemetry logging, interaction debugging, asynchronous stream processing, and reactive accessibility orchestration.

In some embodiments, the frame context layer (205) distributes frame-scoped telemetry through a reactive stream layer (207). The reactive stream layer may include a frame stream (214) configured as a reactive event pipeline, observable sequence, asynchronous telemetry bus, or stream-processing architecture. In certain embodiments, the frame stream distributes immutable frame telemetry to one or more independent interaction streams without blocking sibling interaction pipelines.

In some embodiments, the reactive stream layer (207) generates specialized role-scoped interaction streams including a pointer stream (216), commander stream (218), dwell stream (220), and telemetry stream (222). Each interaction stream may independently process interaction telemetry corresponding to distinct accessibility interaction modalities.

In certain embodiments, the pointer stream (216) processes continuous spatial interaction telemetry including cursor positioning, hover interaction, adaptive button targeting, spatial accessibility interaction, dwell positioning, typing interaction, or gesture-assisted pointer workflows. The pointer stream may further process finger-tip telemetry, finger-straightness telemetry, motion confidence data, dwell persistence information, or adaptive targeting metadata.

In some embodiments, the commander stream (218) independently processes command-oriented interaction telemetry including directional navigation, popup interaction, accessibility control commands, workflow transitions, command shortcuts, confirmation actions, and adaptive accessibility operations. The commander stream may process command gestures independently of pointer interaction such that command execution does not interrupt spatial interaction or dwell workflows.

In certain embodiments, the dwell stream (220) processes dwell interaction telemetry including hover persistence, activation confidence, dwell timers, finger-straightness states, adaptive activation thresholds, gesture persistence intervals, and accessibility confirmation workflows. The dwell stream may generate accessibility activation events without requiring physical clicking, keyboard interaction, or centralized gesture arbitration.

In some embodiments, the telemetry stream (222) processes analytics data, debugging information, interaction metrics, environmental adaptation telemetry, accessibility profiling information, predictive adaptation data, or multimodal interaction metadata. The telemetry stream may further support replay systems, performance analysis, adaptive accessibility tuning, interaction learning systems, or AI-assisted optimization workflows.

In certain embodiments, a HandRoleAssignmentEngine (224) dynamically assigns interaction ownership roles to detected gesture sources. Roles may include pointer, commander, or idle states. In some embodiments, the role assignment engine assigns ownership independently from semantic gesture interpretation such that downstream consumers may independently interpret role-scoped telemetry streams according to application-specific interaction semantics.

In certain embodiments, the role assignment engine dynamically determines ownership based on visibility persistence, interaction continuity, confidence scoring, gesture history, dwell state, environmental context, accessibility preferences, temporal smoothing, or adaptive interaction heuristics. The role assignment engine may further prevent rapid ownership flickering or unintended interaction transitions through stabilization intervals, ownership persistence windows, or adaptive reassignment thresholds.

In some embodiments, the accessibility consumer layer (209) includes one or more independent accessibility interaction systems configured to consume reactive interaction streams without centralized winner-selection arbitration. Such systems may include a ScreenButtonModule (226), typing engine (228), navigation engine (230), dwell engine (232), telemetry and analytics systems (234), and an AI accessibility coach (236).

In certain embodiments, the ScreenButtonModule (226) consumes pointer stream telemetry to support adaptive UI targeting, dwell-based button activation, spatial accessibility interaction, virtual interaction surfaces, multi-finger activation workflows, or gesture-assisted accessibility interaction. The typing engine (228) may consume pointer telemetry to support adaptive text entry, virtual keyboard interaction, predictive typing assistance, gesture-assisted typing, or accessibility-focused communication workflows.

In some embodiments, the navigation engine (230) consumes commander stream telemetry to support directional navigation, popup interaction, accessibility menu traversal, workflow transitions, command execution, adaptive navigation assistance, or accessibility control operations. Because the commander stream operates independently from pointer interaction, command execution may occur concurrently with pointer movement, dwell interaction, or typing workflows.

In certain embodiments, the dwell engine (232) consumes dwell stream telemetry to generate dwell confirmations, accessibility activation events, adaptive dwell thresholds, interaction persistence measurements, or accessibility targeting confidence scores. In some embodiments, finger-straightness states, hover persistence, or motion stability metrics are used to determine adaptive dwell activation confidence.

In some embodiments, telemetry and analytics systems (234) process telemetry streams to generate interaction analytics, accessibility metrics, predictive adaptation models, environmental adaptation data, interaction profiling information, or performance telemetry. Such systems may further support accessibility personalization, adaptive UI optimization, predictive workflow assistance, or multimodal accessibility tuning.

In certain embodiments, the AI accessibility coach (236) consumes one or more reactive interaction streams to generate adaptive accessibility guidance, contextual interaction assistance, multimodal accessibility recommendations, workflow suggestions, predictive interaction coaching, or task-aware accessibility assistance. The AI accessibility coach may dynamically adapt guidance based on interaction telemetry, environmental context, accessibility history, user preferences, or multimodal interaction patterns.

In some embodiments, accessibility consumers within the accessibility consumer layer (209) generate adaptive outputs and feedback actions through the output layer (211). Such outputs may include audio feedback systems (238), visual feedback systems (240), haptic feedback systems (242), adaptive user interface systems (244), personalized guidance systems (246), profile synchronization systems (248), and telemetry logging or improvement systems (250).

In certain embodiments, the reactive interaction orchestration architecture enables simultaneous multimodal accessibility interaction without requiring centralized synchronous gesture arbitration. For example, a first-hand assigned to a pointer role may continue controlling cursor movement, dwell targeting, or accessibility selection while a second hand assigned to a commander role independently performs navigation commands, popup interaction, accessibility control operations, or workflow transitions. Because interaction consumers independently process role-scoped telemetry streams, concurrent accessibility interaction may occur without suppressing sibling interaction pipelines.

In some embodiments, the architecture further supports future extensibility including multi-finger interaction, gesture chords, adaptive accessibility learning, predictive interaction systems, AI-assisted workflow guidance, multimodal accessibility fusion, environment-aware adaptation, Web Worker parallelism, distributed stream processing, replay telemetry systems, or adaptive accessibility orchestration engines without requiring modification of the underlying frame-scoped telemetry architecture.

Although FIG. 2 illustrates interaction streams, role assignment systems, accessibility consumers, and adaptive outputs, other embodiments may employ additional reactive interaction pipelines, multimodal telemetry systems, adaptive accessibility modules, AI interaction engines, gesture-processing architectures, or distributed accessibility workflows without departing from the scope of the present disclosure.

Together, these coordinated components support the system's innovative objectives: to deliver personalized, context-aware, adaptive, and inclusive interaction using commodity hardware and browser-native technologies. The invention addresses unmet needs in accessibility and multimodal interaction by combining user behavior learning, reactive non-blocking interaction orchestration, adaptive gesture processing, role-based interaction ownership, immutable frame-scoped telemetry, personalized profiles, AI-assisted accessibility guidance, and multimodal feedback within a flexible, extensible, and privacy-conscious architecture. In certain embodiments, the architecture enables concurrent accessibility workflows including simultaneous pointer interaction, command execution, dwell activation, navigation, typing, and adaptive guidance without requiring centralized synchronous gesture arbitration.

1. A system for adaptive, gesture-based digital interaction, comprising:
a camera input module configured to capture real-time user gestures;
an environmental sensor interface for detecting ambient conditions such as lighting, orientation, or noise;
a gesture recognition engine that classifies gestures using machine learning models;
an adaptation manager that dynamically adjusts gesture thresholds based on user behavior and environment;
a task mode selector that enables context-specific gesture modes;
a profile manager for importing and exporting shared accessibility profiles;
a UI adapter that reconfigures the interface based on user preference or subscription settings;
an accessibility coach for real-time, AI-driven task guidance using visual or auditory prompts;
a gesture-to-text and gesture-to-voice translator supporting multimodal communication for users with hearing or speech limitations;
a reactive interaction orchestration layer configured to distribute immutable frame-scoped gesture telemetry through multiple independent interaction streams corresponding to distinct interaction modalities.

2. The system of claim 1, wherein the gesture recognition engine supports sign language variants specific to localized regions.

3. The system of claim 1, wherein the environmental sensor interface calibrates gesture detection sensitivity in response to ambient changes.

4. The system of claim 1, wherein the profile manager enables preference migration across devices, platforms, or caregiver accounts.

5. The system of claim 1, wherein the adaptation manager uses behavior tracking to optimize gesture timing, angle, and path.

6. The system of claim 1, wherein the accessibility coach guides the user through tasks such as login, form completion, or navigation with step-by-step feedback.

7. The system of claim 1, wherein the UI adapter modifies gesture complexity, control size, or interface layout based on subscription level or device.

8. The system of claim 1, further comprises a dynamic labeling feature that uses gestures to trigger audio or text descriptions of nearby UI elements.

9. The system of claim 1, wherein separate gesture sources are dynamically assigned interaction ownership roles including pointer, commander, or idle.

10. The system of claim 1, wherein independent interaction streams concurrently support pointer interaction and command execution without centralized gesture arbitration.

11. The system of claim 1, wherein accessibility interaction consumers independently subscribe to role-scoped interaction streams.

12. The system of claim 1, wherein frame-scoped gesture telemetry includes finger-tip telemetry and finger-straightness states used for dwell confirmation and adaptive accessibility interaction.

13. A method for enabling personalized, multimodal accessibility, comprising:
capturing user gestures via a standard camera;
detecting environmental inputs and adjusting gesture sensitivity accordingly;
classifying gesture input with AI-based models;
validating users based on gesture signatures;
selecting task-specific modes to tailor gesture interaction;
applying shared user preferences to UI components;
providing real-time guidance using an accessibility coach;
translating gestures into text, voice, or control commands for hands-free interaction.

14. The method of claim 13, wherein profile settings include gesture precision, control layout, and adaptive interface scaling.

15. The method of claim 13, wherein gesture-to-text translation supports entry into form fields, authentication inputs, or search queries.

16. The method of claim 13, wherein gesture-to-voice output enables auditory feedback for non-verbal users.

17. The method of claim 13, wherein context-aware adaptation switches between simplified and complex gesture sets based on the task.

18. The method of claim 13, wherein the accessibility coach adapts its feedback based on user progress, error patterns, or confidence thresholds.
